(19) United States
(12) Patent Application Publication
(10) Pub. No.: US 2012/0042082 A1
(43) Pub. Date: Feb. 16, 2012

(54) COMMUNICATION SYSTEM AND METHOD FOR USING SESSION INITIATION PROTOCOL IN A NETWORK ADDRESS TRANSLATION ENVIRONMENT

(75) Inventors: Ching-Fu Liao, Taipei (TW); Yu-Jheng Lin, Taipei (TW)

(73) Assignee: CHUNGHWA TELECOM CO., LTD., Taipei (TW)

(21) Appl. No.: 13/208,807

(22) Filed: Aug. 12, 2011

(30) Foreign Application Priority Data
Aug. 13, 2010 (TW) 099127066

(51) Int. Cl. G06F 15/16

(52) U.S. Cl. 709/227

(57) ABSTRACT

A communication system for using the session initiation protocol (SIP) in a network address translation (NAT) environment is provided, which includes a client, a relay server and a SIP server. The relay server is connected to the SIP server and connected to the client through a NAT server. The relay server is configured to establish connection with the client and register with the SIP server so as to allow direct communication between the client and the SIP server, thereby conducting authentication and management of the client and further solving the conventional problem of incompatibility between the SIP server and the client.

### BACKGROUND OF THE INVENTION

1. Field of the Invention

The present invention relates generally to communication systems and methods for using session initiation protocol (SIP), and, more particularly, to a communication system and method for using SIP in a network address translation (NAT) environment.

2. Description of Related Art

Conventionally, voice communications are accomplished via the public switched telephone network (PSTN) provided by telecom companies. The PSTN is a network used for voice communications worldwide and has several hundreds of millions of users. Along with the development of the Internet, voice communications are also implemented over Internet by using solutions such as the voice over Internet protocol (VoIP). VoIP converts analog voice signals from a sending end into digital signals and then transmits the digital signals to a receiving end that further converts the digital signals back into analog voice signals, thereby achieving voice communication over the Internet. Therein, the session initiation protocol (SIP) is one of the most commonly used communication protocols. In addition, an IP PBX supports direct communication of digital signals over the Internet.

Generally, not every computer of an enterprise has or needs a real network address. Accordingly, a network address translation (NAT) technology is required, which enables the enterprise to use virtual network addresses for internal data transmission and communication and translate virtual network addresses and ports to real network addresses and ports through a NAT server for external traffic.

However, some IP PBXs of enterprises may be incompatible with the SIP servers of telecom companies. As such, the IP PBXs cannot register with the SIP servers, or the SIP servers cannot set up SIP trunks to the IP PBXs, thereby preventing direct communication with the IP PBXs. In such a case, it is necessary to use a VoIP gateway that is compatible with the SIP server being used, which, however, can easily lead to poor voice quality and has the potential risk of becoming an obstacle blocking communication. In addition, although some IP PBXs can communicate with SIP servers, the communication is based on trust between the IP PBXs and the SIP servers, thereby making it impossible to authenticate and manage specific IP PBXs. Further, there exist some problems for a VoIP in a NAT environment. For example, when the VoIP registers with a SIP server through a VoIP gateway, since the NAT server translates a virtual network address in an enterprise into a real network address, the SIP server cannot transmit a registration result to the original VoIP gateway, thus adversely affecting registration, authentication and management of the specific VoIP.

Therefore, in a conventional communication system, due to incompatibility between a client, such as an IP PBX or a VoIP gateway, and a SIP server of a limited NAT environment, the client cannot register with the SIP server or the SIP server cannot provide authentication and management mechanisms to the client. Therefore, it is imperative to provide a communication method and system so as to overcome the above-described drawbacks.

### SUMMARY OF THE INVENTION

Accordingly, the present invention provides a communication system and method for using SIP in a NAT environment so as to overcome the conventional drawback of incompatibility between a SIP server and a client and meanwhile provide authentication and management mechanisms to the client.

According to an aspect of the present invention, a communication method for using SIP in a NAT environment comprises the steps of: establishing a connection between a relay server and a client; registering the relay server with a SIP server; having the client use the SIP to transmit a communication request through a NAT server and the relay server to the SIP server; and, after checking the content of a SIP packet containing the communication request and received by the SIP server, having the SIP server determine whether to permit the communication request and transmitting the determination result through the relay server to the client.

The present invention further provides a communication system for using SIP in a NAT environment, which comprises: a client built on the Internet; a relay server built on the Internet and connected with the client through a NAT server; and a SIP server built on the Internet and connected with the relay server, wherein the SIP server is configured to establish a connection with the client, the relay server is configured to register with the SIP server, the client is configured to use the SIP to transmit a communication request through the NAT server and the relay server to the SIP server, and the SIP server is configured to check the content of a SIP packet containing the communication request and received by the SIP server, so as to determine whether to permit the communication request and transmit the determination result through the relay server to the client.

Compared with the prior art, the present invention uses a relay server to establish connection with a client and further enable the relay server to register with a SIP server so as to allow direct communication between the client and the SIP server, thereby overcoming the conventional drawback of incompatibility between a SIP server and a client and meanwhile providing authentication and management mechanisms to the client.

### BRIEF DESCRIPTION OF DRAWINGS

FIG. 1 is a block diagram showing the structure of a communication system for using SIP in a NAT environment according to a first embodiment of the present invention;

FIG. 2 is a flow diagram showing a communication method for using SIP in a NAT environment according to the first embodiment of the present invention;

FIG. 3 is a block diagram showing the structure of a communication system for using SIP in a NAT environment according to a second embodiment of the present invention; and

FIG. 4 is a flow diagram showing a communication method for using SIP in a NAT environment according to the second embodiment of the present invention.

### DETAILED DESCRIPTION OF PREFERRED EMBODIMENTS

The following illustrative embodiments are provided to illustrate the disclosure of the present invention and its advantages, these and other advantages and effects being apparent to those in the art after reading this specification.

### First Embodiment

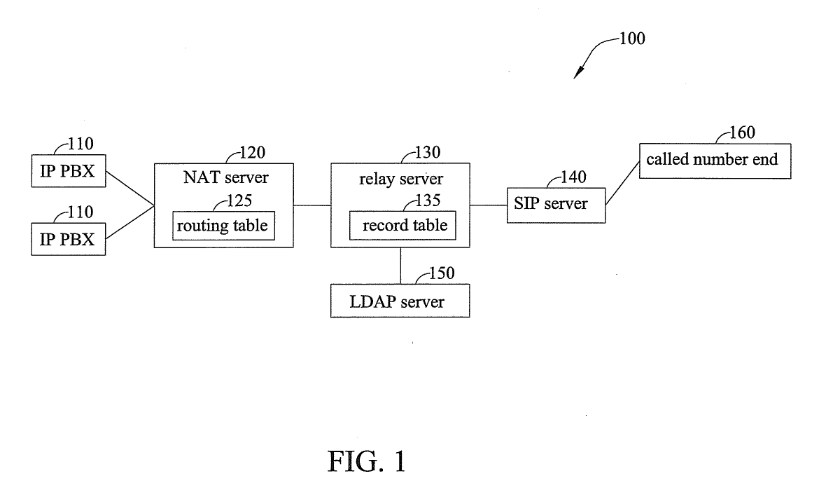

FIG. 1 shows the structure of a communication system 100 for using SIP in a NAT environment according to a first embodiment of the present invention.

Referring to FIG. 1, the communication system 100 is established on the Internet and has: an IP PBX 110, a NAT server 120, a relay server 130 and a SIP server 140. Therein, the SIP server 140 is, but is not limited to, a multimedia communication server. The relay server 130 has a record table 135 for recording communication data, such as communication times, between the SIP server 140 and the IP PBX 110. The NAT server 120 has a routing table 125 for recording addresses and ports before translation by the NAT server and addresses and ports after translation by the NAT server. The present embodiment shows two IP PBXs, but it is not limited thereto.

In the communication system 100, the IP PBX 110 is connected with the NAT server 120 such that the NAT server 120 translates input virtual addresses and ports into real addresses and ports and stores the virtual and real addresses and ports in the routing table 125. The relay server 130 is connected with the IP PBX 110 through the NAT server 120. The SIP server 140 is connected with the relay server 130.

The communication system 100 further has a lightweight directory access protocol (LDAP) server 150, which is connected with the relay server 130 for managing accounts and passwords.

The communication system 100 further has a called number end 160, which is connected with SIP server 140 for transmitting communication packets.

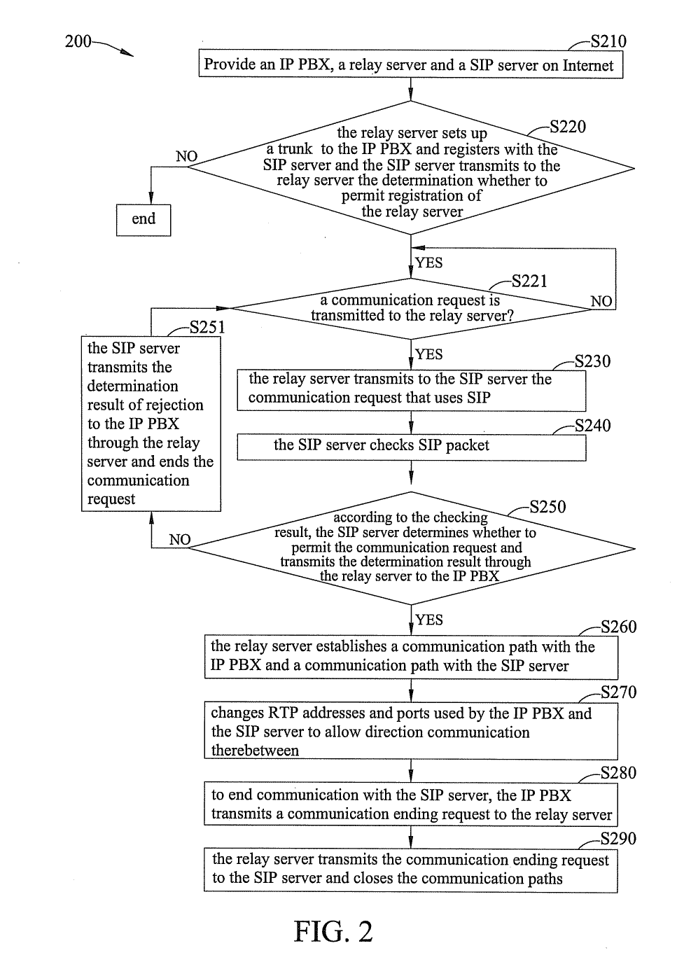

FIG. 2 shows the flow process of a communication method 200 for using SIP in a NAT environment according to the first embodiment of the present invention.

Referring to FIG. 2, at step S210, an IP PBX 110, a relay server 130 and a SIP server 140 are provided on the Internet, wherein the relay server 130 is connected with the SIP server 140 and further connected with the IP PBX 110 through a NAT server 120. Then, the process goes to step S220.

At step S220, the relay server 130 sets up a trunk to the IP PBX 110 and registers with the SIP server 140, wherein the SIP server 140 checks the account and/or password so as to determine whether to permit registration of the relay server 130 and transmits the determination result to the relay server 130. If the relay server 130 is permitted to register, a positive determination result granting permission is transmitted to the relay server 130 and the process goes to step S221, otherwise, a negative determination result indicating rejection is transmitted to the relay server 130 and the process is ended.

At step S221, the relay server 130 listens to determine whether a communication request is transmitted to the relay server 130, wherein, if one is transmitted, the process goes to step S230, and, otherwise, the relay server 130 continues to listen.

At step S230, when the IP PBX 110 uses SIP to transmit a communication request through the NAT server 120 to the relay server 130, the relay server 130 transmits the communication request to the SIP server 140. Therein, the relay server 130 changes the content of the SIP packet containing the communication request. Preferably, the header source of the SIP packet is changed from its address and port before translation by the NAT server 120 to the address and port of the relay server 130. Then, the process goes to step S240.

At step S240, the SIP server 140 checks the SIP packet, which involves checking the address and port, account, SIP domain, called number and/or maximum number of calls at the same time. Then, the process goes to step S250.

At step S250, according to the checking result, the SIP server 140 determines whether to permit the communication request, and, after verifying that the communication condition of the called number end 160 is normal, the SIP server 140 transmits the determination result through the relay server 130 to the IP PBX 110. Therein, when the SIP server 140 uses SIP to transmit the determination result through the relay server 130 to the IP PBX 110, the relay server 130 changes the content of the SIP packet. Preferably, the header source of the SIP packet is changed from the address and port of the SIP server 140 to the address and port before translation by the NAT server 120. If the communication request is permitted, then the process goes to step S260, and, otherwise, the process goes to step S251.

At step S251, the SIP server 140 transmits the determination result of rejection to the IP PBX 110 through the relay server 130 and ends the communication request. Then, the process goes to step S221. In other embodiments, after the communication request is ended, the process can be selectively ended.

At step S260, the SIP server 140 transmits the positive determination result granting permission to the IP PBX 110 through the relay server 130, and the relay server 130 establishes a communication path with the IP PBX 110 and chooses to use an account corresponding to the SIP server 140 so as to establish a communication path with the SIP server 140, thereby transmitting communication packets to the called number end 160. The relay server 130 records communication data such as the time of establishing of the communication paths so as to authenticate and manage the IP PBX 110. Then, the process goes to step S270.

At step S270, when the IP PBX 110 transmits a communication packet to the relay server 130, the relay server 130 records the real-time transfer protocol (RTP) address and port used by the IP PBX 110. Subsequently, the relay server 130 sends a re-invite request to the IP PBX 110 and changes the RTP address and port used by the IP PBX 110 so as to allow direct communication between the IP PBX 110 and the SIP server 140. When the SIP server 140 transmits a communication packet to the relay server 130, the relay server 130 records the RTP address and port used by the SIP server 140. Additionally, the relay server 130 sends a re-invite request to the SIP server 140 and changes the RTP address and port used by the SIP server 140 so as to allow direct communication between the IP PBX 110 and the SIP server 140. Then, the process goes to step S280.

At step S280, in order to end communication with the SIP server 140, the IP PBX 110 transmits a communication-ending request to the relay server 130 and the relay server 130 records communication data such as the time of closing of the communication paths so as to authenticate and mange the IP PBX 110. Then, the process goes to step S290.

At step S290, the relay server 130 transmits the communication-ending request to the SIP server 140 and closes the communication paths and processes the communication data related to the establishing and closing of the communication paths so as to authenticate and mange the IP PBX 110. For example, based on the time of establishing of the communication paths and the time of closing the communication paths, the relay server 130 can calculate communication expenses, but it is not limited thereto.

### Second Embodiment

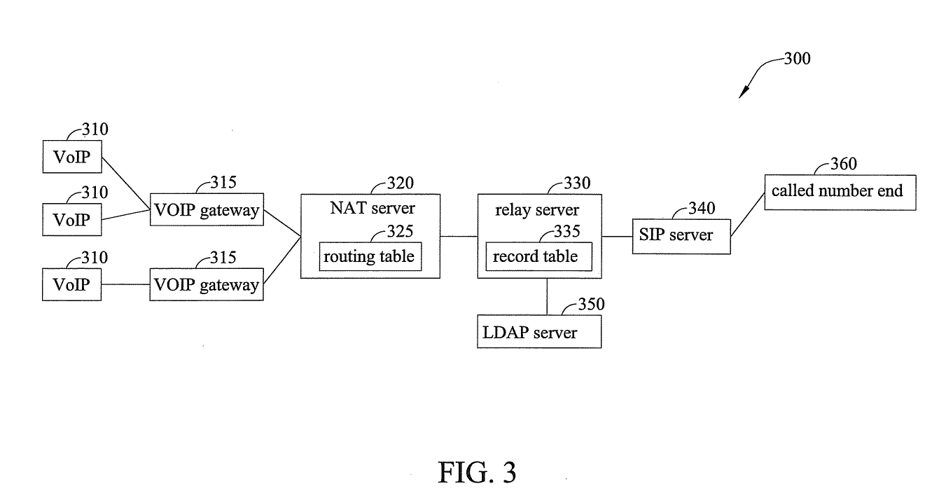

FIG. 3 shows the structure of a communication system 300 for using SIP in a NAT environment according to a second embodiment of the present invention. The main difference of the present embodiment from the first embodiment is that the present embodiment uses a VoIP device and a VoIP gateway instead of the IP PBX of the first embodiment. Since the application environment and steps of the present embodiment are the same as those of the first embodiment, detailed description thereof is omitted herein.

Referring to FIG. 3, the communication system 300 is interconnected with the Internet and comprises: a VoIP device 310, a VoIP gateway 315, a NAT server 320, a relay server 330 and a SIP server 340. Therein, the VoIP device 310 is connected with the VoIP gateway 315, and the VoIP gateway 315 is connected with the NAT server 320. The NAT server 320 translates input virtual addresses and ports into real addresses and ports and stores the virtual and real addresses and ports in a routing table 325. The relay server 330 is connected with the VoIP gateway 315 through the NAT server 320, and the relay server 330 has a record table 335. The SIP server 340 is connected with the relay server 330. Although FIG. 3 shows a plurality of VoIP devices and VoIP gateways, it should be noted that the number of VoIP devices and the number of VoIP gateways shown in the drawing are only for illustrative purposes and not intended to limit the present invention.

The communication system 300 further has an LDAP server 350, which is connected with the relay server 330 for managing accounts and passwords.

The communication system 300 further has a called number end 360, which is connected with SIP server 340 for transmitting communication packets.

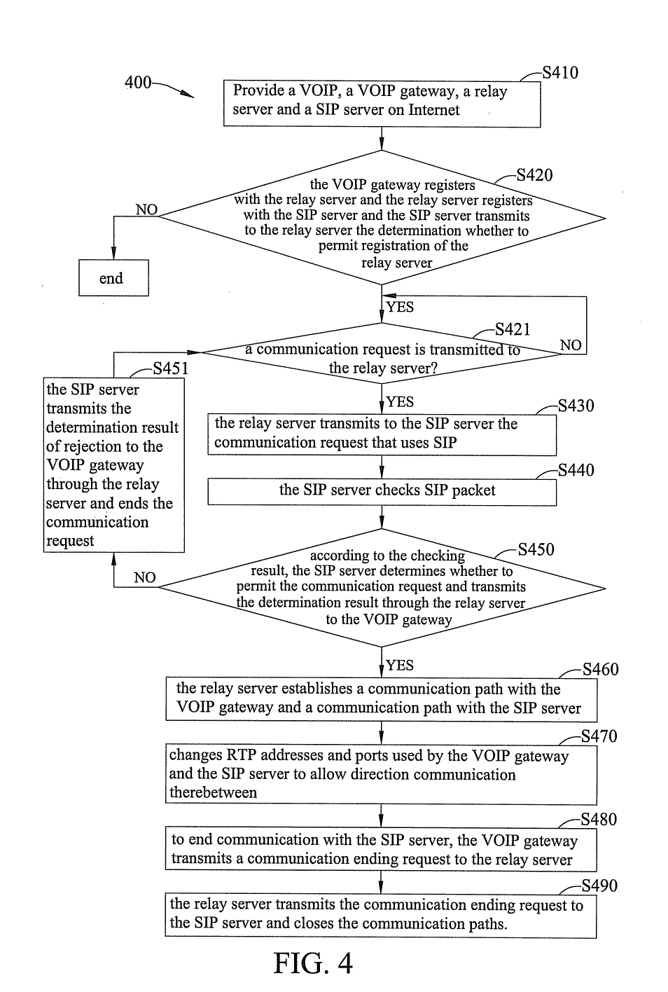

FIG. 4 shows the flow process of a communication method 400 for using SIP in a NAT environment according to the second embodiment of the present invention.

Referring to FIG. 4, at step S410, a VoIP device 310, a VoIP gateway 315, a relay server 330 and a SIP server 340 are provided on the Internet. Therein, the VoIP device 310 is connected with the VoIP gateway 315, and the relay server 330 is connected with the SIP server 340 and further connected with the VoIP gateway 315 through a NAT server 320. Then, the process goes to step S420.

At step S420, the VoIP gateway 315 registers with the relay server 330 and the relay server 330 registers with the SIP server 340, wherein the SIP server 340 checks account and/or password data so as to determine whether to permit registration of the relay server 330 and transmits the determination result to the relay server 330. If the relay server 330 is permitted to register, a positive determination result granting permission is transmitted to the relay server 330 and the process goes to step S421, otherwise, a negative determination result indicating rejection is transmitted to the relay server 330 and the process is ended.

At step S421, the relay server 330 listens to determine whether a communication request is transmitted to the relay server 330, wherein, if one is transmitted, the process goes to step S430, and, otherwise, the relay server 330 continues to listen.

At step S430, when the VoIP gateway 315 uses SIP to transmit a communication request through the NAT server 320 to the relay server 330, the relay server 330 transmits the communication request to the SIP server 340. Therein, the relay server 330 changes the content of the SIP packet. Preferably, the header source of the SIP packet is changed from the address and port before translation by the NAT server 320 to the address and port of the relay server 330. Then, the process goes to step S440.

At step S440, the SIP server 340 checks the SIP packet, which involves checking the address and port, account, SIP domain, called number and/or maximum number of calls at the same time. Then, the process goes to step S450.

At step S450, according to the checking result, the SIP server 340 determines whether to permit the communication request, and, after verifying that the communication condition of the called number end 360 is normal, the SIP server 340 transmits the determination result through the relay server 330 to the VoIP gateway 315. Therein, when the SIP server 340 uses SIP to transmit the determination result through the relay server 330 to the VoIP gateway 315, the relay server 330 changes the content of the SIP packet. Preferably, the header source of the SIP packet is changed from the address and port of the SIP server 340 to the address and port before translation by the NAT server 320. If the communication request is permitted, the process goes to step S460, and, otherwise, the process goes to step S451.

At step S451, the SIP server 340 transmits a negative determination result indicating rejection to the VoIP gateway 315 through the relay server 330 and ends the communication request. Then, the process goes to step S421. In other embodiments, after the communication request is ended, the process can be selectively ended.

At step S460, the SIP server 340 transmits the positive determination result granting permission to the VoIP gateway 315 through the relay server 330, and the relay server 330 establishes a communication path with the VoIP gateway 315 and chooses to use an account corresponding to the SIP server 340 so as to establish a communication path with the SIP server 340, thereby transmitting communication packets to the called number end 360. The relay server 330 records communication data such as the time of establishing of the communication paths so as to authenticate and manage the VoIP gateway 315. Then, the process goes to step S470.

At step S470, when the VoIP gateway 315 transmits a communication packet to the relay server 330, the relay server 330 records the RTP address and port used by the VoIP gateway 315. Additionally, the relay server 330 sends a re-invite request to the VoIP gateway 315 and changes the RTP address and port used by the VoIP gateway 315 so as to allow direct communication between the VoIP gateway 315 and the SIP server 340. When the SIP server 340 transmits a communication packet to the relay server 330, the relay server 330 records RTP address and port used by the SIP server 340. Moreover, the relay server 330 sends a re-invite request to the SIP server 340 and changes the RTP address and port used by the SIP server 340 so as to allow direct communication between the VoIP gateway 315 and the SIP server 340. Then, the process goes to step S480.

At step S480, in order to end communication with the SIP server 340, the VoIP gateway 315 transmits a communication-ending request to the relay server 330 and the relay server 330 records communication data, such as the time of closing of the communication paths, so as to authenticate and mange the VoIP gateway 315. Then, the process goes to step S490.

At step S490, the relay server 330 transmits the communication-ending request to the SIP server 340 and close the communication paths and process the communication data related to the establishing and closing of the communication paths so as to authenticate and mange the VoIP gateway 315. For example, based on the time of establishing of the communication paths and the time of closing the communication paths, the relay server 330 can calculate communication expenses, but it is not limited thereto.

For example, at step S410, suppose that the address of the VoIP gateway 315 is 192.168.1.1, the address of the NAT server 320 is 10.254.254.1, the address of the relay server 330 is 61.219.12.36 and the address of the SIP server 340 is 203.66.96.148. Next, the process goes to step S420, as described previously.

At step S420, the VoIP gateway 315 registers with the relay server 330 and the relay server 330 registers with the SIP server 340. Then, the process goes to step S421.

At step S421, when the relay server 430 receives a communication request from the VoIP gateway 315 using SIP, the process goes to step S430.

At step S430, the relay server 330 changes the header source of the SIP packet from the address and port before translation by the NAT server 320 to the address and port of the relay server 330. That is, the head source of the SIP packet is changed from 192.168.1.1:12345 to 61.219.12.36:54321. Then, the process goes to step S440.

At step S440, the SIP server 340 checks the SIP packet of the SIP. Then, the process goes to step S450.

At step S450, the relay server 330 changes the header source of the SIP packet from the address and port of the SIP server 340 to the address and port before translation by the NAT server 320. That is, the header source of the SIP packet is changed from 203.66.96.148:54321 to 192.168.1.1:12345. Then, the process goes to step S460.

At step S460, the SIP server 340 transmits the positive determination result granting permission to the VoIP gateway 315 through the relay server 330. Then, the process goes to step S470.

At step S470, the relay server 330 changes the RTP address and port used by the VoIP gateway 315 and the RTP address and port used by the SIP server 340 so as to allow direct communication between the VoIP gateway 315 and the SIP server 340. That is, the RTP address and port used by the VoIP gateway 315 is changed from 61.219.12.36:54321 to 203.66.96.148:54321 and the RTP address and port used by the SIP server 340 is changed from 61.219.12.36:54321 to 10.254.254.1:54321. Then, the process goes to step S480.

At step S480, in order to end communication with the SIP server 340, the VoIP gateway 315 transmits a communication-ending request to the relay server 330. Then, the process goes to step S490.

At step S490, the relay server 330 transmits the communication-ending request to the SIP server 340 and closes the communication paths.

In the above-described embodiment, the IP PBX and the VoIP gateway can be referred to as clients, and the relay server setting up a trunk to the IP PBX and the VoIP gateway registering with the relay server can be referred to as establishing a connection between the relay server and the clients.

The above-described descriptions of the detailed embodiments are provided to illustrate the preferred implementation according to the present invention, and are not intended to limit the scope of the present invention. Accordingly, many modifications and variations completed by those with ordinary skill in the art can be made and yet still fall within the scope of the present invention as defined by the appended claims.

What is claimed is:

1. A communication method for using session initiation protocol (SIP) in a network address translation (NAT) environment, comprising the steps of:
establishing a connection between a relay server and a client;
registering the relay server with a SIP server;
using the SIP by the client to transmit a communication request through a NAT server and the relay server to the SIP server; and
after checking content of a SIP packet containing the communication request and received by the SIP server, having the SIP server determine whether to permit the communication request and then transmit a corresponding determination result through the relay server to the client.

2. The method of claim 1, wherein the client is built on the Internet; the relay server is built on the Internet and connected with the client through the NAT server; and the SIP server is built on the Internet and connected with the relay server.

3. The method of claim 1, further comprising, when the SIP server determines that the communication request is permitted, having the SIP server transmit a positive determination result granting permission through the relay server to the client, and having the relay server establish a communication path with the client and choose to use an account corresponding to the SIP server so as to establish a communication path with the SIP server.

4. The method of claim 1, further comprising, when the SIP server determines that the communication request is rejected, having the SIP server transmit a negative determination result through the relay server to the client and ending the communication request.

5. The method of claim 1, wherein, when registering the relay server with the SIP server, the SIP server checks account and/or password data to determine whether to permit registration of the relay server and then transmits a determination result to the relay server.

6. The method of claim 1, wherein, when the client uses the SIP to transmit the communication request through the NAT server and the relay server to the SIP server, the relay server changes the content of the packet of the SIP.

7. The method of claim 6, wherein the step of changing the content of the packet of the SIP refers to changing a header source of the packet of the SIP from an address and a port of the client before translation by the NAT server to an address and a port of the relay server.

8. The method of claim 1, wherein the step of checking SIP packet involves checking the address and port, account, SIP domain, called number and/or maximum number of calls at the same time.

9. The method of claim 3, further comprising:
in order to end communication with the SIP server, transmitting by the client a communication-ending request to the relay server;
transmitting by the relay server the communication-ending request to the SIP server; and
closing the communication path by the relay server.

10. The method of claim 9, wherein the relay server records communication data related to the establishing and closing of the communication path.

11. The method of claim 10, wherein the communication data refer to communication time.

12. The method of claim 3, further comprising:
when the client transmits a communication packet to the relay server, having the relay server record real-time transfer protocol (RTP) address and port used by the client; and
having the relay server transmit a re-invite request to the client and change the RTP address and port used by the client so as to allow direct communication between the client and the SIP server.

13. The method of claim 12, further comprising:
when the SIP server transmits a communication packet to the relay server, having the relay server record the RTP address and port used by the SIP server; and
having the relay server transmit a re-invite request to the SIP server and change the RTP address and port used by the SIP server so as to allow direct communication between the client and the SIP server.

14. The method of claim 1, wherein the client is one of a VoIP gateway and an IP PBX.

15. The method of claim 14, wherein, if the client is a VoIP gateway, the client registers with the relay server to establish a connection between the client and the relay server.

16. The method of claim 14, wherein, if the client is an IP PBX, the relay server sets up a trunk to the client to establish a connection between the client and the relay server.

17. The method of claim 1, wherein the SIP server is a multimedia communication server.

18. A communication system for using SIP in a NAT environment, comprising:
a client built on the Internet;
a relay server built on the Internet and connected with the client through a NAT server; and
a SIP server built on the Internet and connected with the relay server,
wherein the SIP server is configured to establish a connection with the client, the relay server is configured to register with the SIP server, the client is configured to use SIP to transmit a communication request through the NAT server and the relay server to the SIP server, and the SIP server is configured to check content of a SIP packet containing the communication request and received by the SIP server so as to determine whether to permit the communication request and transmit a corresponding determination result through the relay server to the client.

19. The system of claim 18, wherein the client is one of a VoIP gateway and an IP PBX.

20. The system of claim 18, wherein the SIP server is a multimedia communication server.

21. The system of claim 18, wherein the relay server is configured to change the content of the SIP packet.

22. The system of claim 21, wherein the relay server is configured to change the header source of the SIP packet from an address and a port of the client before translation by the NAT server to an address and a port of the relay server.

23. The system of claim 18, further comprising a lightweight directory access protocol (LDAP) server built on the Internet and connected with the relay server for managing accounts and passwords.

24. The system of claim 18, wherein the relay server has a record table for recording communication data between the client and the SIP server.

25. The system of claim 24, wherein the record table is used for recording communication time between the client and the SIP server.
